(19) United States
(12) Patent Application Publication
(10) Pub. No.: US 2025/0349870 A1
(43) Pub. Date: Nov. 13, 2025

(54) EMITTERS FOR CELL VOLTAGE MONITORING

(71) Applicant: ZeroAvia, Inc., Hollister, CA (US)

(72) Inventor: Valery MIFTAKHOV, Hollister, CA (US)

(21) Appl. No.: 18/657,617

(22) Filed: May 7, 2024

(51) Int. Cl. H01M 8/04537; G06T 7/90; H01M 8/0432; H01M 8/04858; H01M 8/249

(52) U.S. Cl. CPC H01M 8/04559; H01M 8/04873; H01M 8/249; G06T 7/90; H01M 8/0432

(57) ABSTRACT

A system for monitoring a voltage condition of a fuel cell (FC) stack includes at least two FCs operating together in series. At least one light-emitting diode (LED) is in electrical communication with the at least two FCs. At least one sensor is in visual communication with the at least one LED to receive a visual emission from the at least one LED. At least one processor is in communication with the at least one sensor. The at least one processor has a computer-readable memory and a power supply. A brightness of the at least one LED is determined by a voltage condition of the at least two FCs.

### TECHNICAL FIELD

The present disclosure relates to voltage monitoring of fuel cells. The disclosure has particular utility for wireless monitoring of voltage conditions of fuel cells (FCs) although other utilities are contemplated.

### BACKGROUND AND SUMMARY

This section contains background information related to the present disclosure which is not necessarily prior art, and is related to the present disclosure. This section provides a general summary of the disclosure and is not a comprehensive disclosure of its full scope or all its features. An FC is an electrochemical cell that converts chemical energy into electrical energy by spontaneous electrochemical reduction-oxidation (redox) reactions. FCs include an anode and a cathode separated by an ionically conductive electrolyte. During operation, a fuel (e.g., hydrogen) is supplied to the anode and an oxidant (e.g., oxygen or air) is supplied to the cathode. The fuel is oxidized at the anode, producing positively charged ions (e.g., hydrogen ions) and electrons. The positively charged ions travel through the electrolyte from the anode to the cathode, while the electrons simultaneously travel from the anode to the cathode outside the cell via an external circuit, which produces an electric current. The oxidant supplied to the cathode is reduced by the electrons arriving from the external circuit and combines with the positively charged ions to form water.

FCs may be used as power sources for electric motors of electric vehicles and hybrid electric vehicles, including aircraft. In such applications, FCs oftentimes are arranged in stacks of multiple cells and connected in a series or parallel arrangement to achieve a desired power and output voltage. FC stacks operate in conditions hostile to the survivability of electronic components, including elevated temperatures, high humidity, and continuous vibration.

However, it is necessary to monitor the voltage output of each FC during operation to ensure that the FCs are performing sufficiently, and that catastrophic events, such as failure or destruction of an FC, do not occur.

Existing cell voltage monitoring systems (CVMs) comprise hardwired electrical components which are passed through the hostile environmental conditions of the FC stacks to controllers to receive and analyze FC voltage data. These electrical components are a common site of mechanical failure due to deterioration from the environment. Moreover, they add considerable physical bulk to the FC stack, which inhibits the flow of air to the FC, thus inhibiting cooling of the FC stack. Referring to FIG. 1, one prior art CVM 10 employs a series of cell voltage monitoring acquisition hardware 18 directly connected at a side face of the FC 12. While other sensors, such as temperature sensors 14 and current sensors 16 are minor and unobtrusive, the CVM acquisition hardware 18 extends completely along the side face of the FC 12, adding considerable bulk and blocking airflow to that entire portion of the FC 12. In addition, the direct mechanical connection of the components in the hot, humid, vibration-heavy environment is a known failure mode of the CVM 10.

The present disclosure can be viewed as providing a system for monitoring a voltage condition of an FC stack. Briefly described, in architecture, one embodiment of the system, among others, can be implemented as follows. At least two FCs are operated together in series. At least one light-emitting diode (LED) is in electrical communication with the at least two FCs. At least one sensor is in visual communication with the at least one LED to receive a visual emission from the at least one LED. At least one processor is in communication with the at least one sensor. The at least one processor has a computer-readable memory and a power supply. A brightness of the at least one LED is determined by a voltage condition of the at least two FCs.

In one aspect of the disclosure, the at least two FCs operating together in series form an FC module, wherein each FC module consists of two or more FCs, and wherein the system comprises a plurality of FC modules. In a particular aspect of the disclosure, the at least one LED is one LED corresponding to each FC module.

In another aspect of the disclosure, the at least one LED is a plurality of LEDs, wherein each LED in the plurality of LEDs are connected across at least two FCs operating together in series to comprise an LED circuit, and wherein each FC is connected to at least 2 LED circuits.

In another aspect of the disclosure, the at least one LED is a plurality of LEDs, wherein a circuit branch containing each LED has a resistance property different from a circuit branch containing each other LED, and whereby each LED is activated to emit light under a different voltage condition than each other LED. In a particular aspect, a first circuit branch has a first resistance property requiring a first voltage condition to cause emission of the first LED, and wherein a second circuit branch has a second resistance property requiring a second voltage condition greater than the first voltage condition to cause emission of the first LED.

In another aspect of the disclosure, the visual emission from the at least one LED is emitted on a periodic cycle.

In another aspect of the disclosure, at least one DC-DC converter is in electrical communication with the at least one LED.

The present disclosure can also be viewed as providing a system for monitoring a voltage condition of an FC stack. Briefly described, in architecture, one embodiment of the system, among others, can be implemented as follows. At least one emitting acoustic transducer is in electrical communication with the at least one FC. At least one receiving acoustic sensor is in audio communication with the at least one emitting acoustic transducer to receive an acoustic emission from the at least one emitting acoustic transducer. At least one processor is in communication with the at least one receiving acoustic sensor. The at least one processor has a computer-readable memory and a power supply. An intensity or frequency of the acoustic emission from the at least one emitting acoustic transducer is responsive to a voltage condition of the at least one FC.

In one aspect of the disclosure, the at least one emitting acoustic transducer is one emitting acoustic transducer corresponding to a plurality of FCs.

In another aspect of the disclosure, the at least one emitting acoustic transducer emits a signal in the ultrasonic range between 1 and 100 MHz.

In another aspect of the disclosure, the at least one FC and the at least one emitting acoustic transducer are enclosed within a mechanical enclosure.

In another aspect of the disclosure, the at least one receiving acoustic sensor is a linear array of receiving acoustic sensors. In a particular aspect, at least one receiving acoustic sensor corresponds to each emitting acoustic transducer.

In another aspect of the disclosure, the acoustic emission of at least two emitting acoustic transducers is timed to direct an interference signal to the at least one receiving acoustic sensor.

The present disclosure can also be viewed as providing methods of monitoring a voltage condition of an FC stack. In this regard, one embodiment of such a method, among others, can be broadly summarized by the following steps: operating at least two FCs together in series; receiving, with at least one visual sensor, an emission from at least one light-emitting diode (LED) in electrical communication with the at least two FCs, wherein the at least one visual sensor is in visual communication with the at least one LED; and determining, by at least one processor in communication with the at least one visual sensor, a voltage condition of the at least two FCs, wherein the at least one processor is configured to: measure a luminosity value for an area on the at least one visual sensor; determine whether the measured luminosity value is within a range corresponding to a nominal operating voltage; and if a measured luminosity value is determined to be outside of the nominal operating range, identify at least one FC corresponding to the measured luminosity value.

In one aspect of the disclosure, the determination of the voltage condition is made using at least one from the set of: machine-learning-based image segmentation models, computer vision processing, and artificial intelligence detection.

In one aspect of the disclosure, the processor is further configured to perform at least one from the set of: communicate the identified at least one FC to a user in order to adjust the at least one FC output, and automatically adjust the at least one FC output.

In one aspect of the disclosure, the method further comprises the following steps: receiving with the at least one visual sensor, an emission from the at least one LED in electrical communication with an additional sensor component of the at least two FCs; and determining, by the at least one processor, at least one from the set of: a temperature condition and a chemical environment condition of the at least two FCs, wherein the at least one processor is configured to: measure a luminosity value for an area on the at least one visual sensor; correlate the measured luminosity value to a temperature condition value or a chemical environment condition value; and identify at least one FC corresponding to the measured luminosity value.

The present disclosure can also be viewed as providing methods of monitoring a voltage condition of an FC stack. In this regard, one embodiment of such a method, among others, can be broadly summarized by the following steps: operating at least one FC; receiving, with at least one visual sensor, an emission from at least one light-emitting diode (LED) in electrical communication with the at least one FC, wherein the at least one visual sensor is in visual communication with the at least one LED; and determining, by at least one processor in communication with the at least one visual sensor, a voltage condition of the at least one FC, wherein the at least one processor is configured to: measure a wavelength value for an area on the at least one visual sensor; determine whether the measured wavelength value corresponds to a nominal operating voltage; and if a measured wavelength value corresponds to a voltage outside the nominal operating range, identify at least one FC corresponding to the measured wavelength.

In one aspect of the disclosure, the determination of the voltage condition is made by analyzing a phase characteristic of the emission from the at least one emitting acoustic transducer.

In another aspect of the disclosure, the step of identifying at least one FC corresponding to the measured intensity value is performed by analyzing a time of signal arrival to the at least one receiving acoustic sensor.

In another aspect of the disclosure, the step of determining a voltage condition is made by measuring a frequency of the emission from the at least one emitting acoustic transducer.

In another aspect of the disclosure, the processor is further configured to perform at least one from the set of: communicate the identified at least one FC to a user in order to adjust the at least one FC output; and automatically adjust the at least one FC output without requiring user input.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

In the drawings:

FIG. 1 is a diagrammatic illustration of a prior art FC voltage monitoring system.

FIG. 2A is a diagrammatic illustration of a system for monitoring a voltage condition of an FC stack using an LED, in accordance with a first exemplary embodiment of the present disclosure.

FIG. 2B is a diagrammatic illustration of the system for monitoring a voltage condition of an FC stack of FIG. 2A in operation with multiple LED circuits, in accordance with the first exemplary embodiment of the present disclosure.

FIG. 3 is a diagrammatic illustration of the system for monitoring a voltage condition of an FC stack of FIG. 2A in operation with an FC stack, in accordance with the first exemplary embodiment of the present disclosure.

FIG. 4 is a diagrammatic illustration of the system for monitoring a voltage condition of an FC stack using multiple LEDs, in accordance with the first exemplary embodiment of the present disclosure.

FIG. 5 is a diagrammatic illustration of the system for monitoring a voltage condition of an FC stack using multiple LEDs in operation with an FC stack, in accordance with the first exemplary embodiment of the present disclosure.

FIG. 6 is a diagrammatic illustration of the system for monitoring a voltage condition of an FC stack using LED arrays, in accordance with the first exemplary embodiment of the present disclosure.

FIG. 7 is a diagrammatic illustration of a system for monitoring a voltage condition of an FC stack using acoustic transducers, in accordance with a second exemplary embodiment of the present disclosure.

FIG. 8 is a diagrammatic illustration of the system for monitoring a voltage condition of an FC stack using acoustic transducers in operation with an FC stack, in accordance with the second exemplary embodiment of the present disclosure.

FIG. 9 is a diagrammatic illustration of the system for monitoring a voltage condition of an FC stack using acoustic transducers in a phase-steering operational mode, in accordance with the second exemplary embodiment of the present disclosure.

FIG. 10 is a flow chart illustrating a method for monitoring a voltage condition of an FC stack using LEDs, in accordance with the first exemplary embodiment of the present disclosure.

FIG. 11 is a flow chart illustrating a method for monitoring a voltage condition of an FC stack using acoustic transducers, in accordance with the second exemplary embodiment of the present disclosure.

FIG. 12 is a diagrammatic illustration of a system for monitoring a voltage condition of an FC stack using acoustic transducers, in accordance with the second exemplary embodiment of the present disclosure.

FIG. 13 is a flow chart illustrating a method for monitoring a voltage condition of an FC stack using acoustic transducers, in accordance with the second exemplary embodiment of the present disclosure.

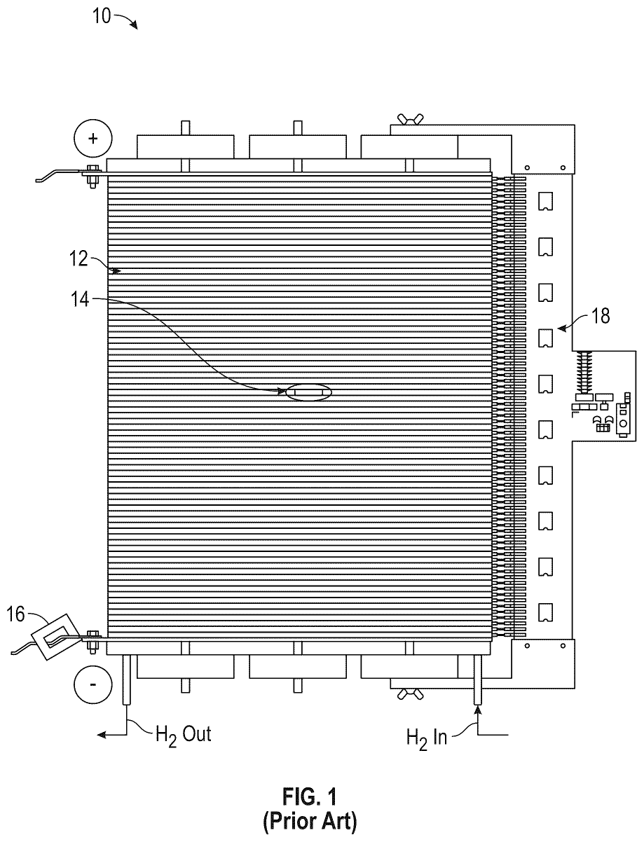

### DETAILED DESCRIPTION

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers, and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In this disclosure, the term “voltage condition” may be understood as a characteristic relating to the electrical voltage, particularly when referring to an FC, an FC module, or an FC stack. For example, a voltage condition may refer to the voltage or potential difference between two points in an FC circuit. A voltage condition may also refer to the increase, decrease, or maintenance of a potential difference, or to any other characteristic involving the voltage of an FC.

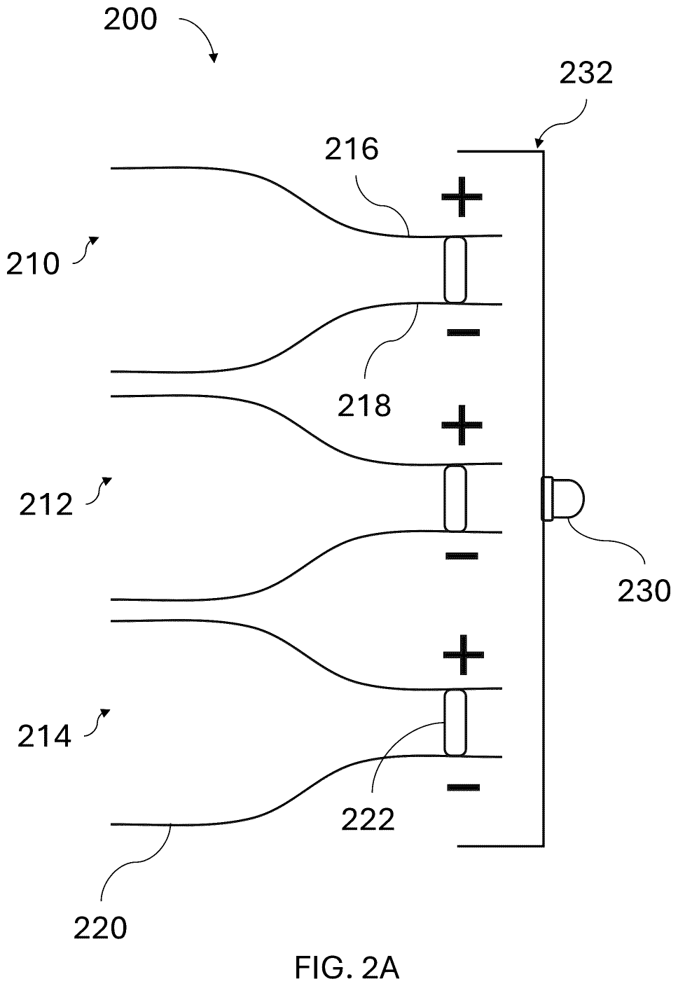

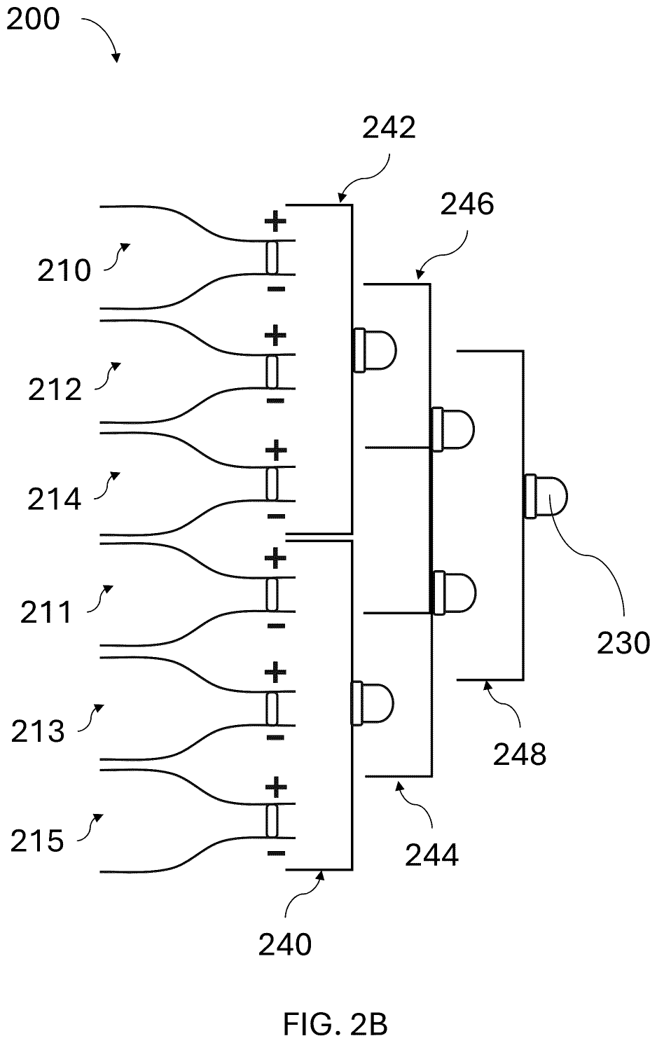

FIGS. 2A-3 are diagrammatic illustrations of a system for monitoring a voltage condition of an FC stack (“system”) 200 using an LED 230, in accordance with a first exemplary embodiment of the present disclosure. FIG. 2A illustrates a portion of the system 200 that includes the FC components and the LED emitter components. FIG. 3 illustrates a portion of the system 200 that includes the FC components in operation as an FC stack 301, along with a sensor 330 and processor 340 to receive the voltage condition information. At least two FCs 210, 212, 214 are operated together in series. At least one LED 230 is in electrical communication with the at least two FCs 210, 212, 214. At least one sensor 330 is in visual communication with the at least one LED 230 to receive a visual emission from the at least one LED 230. At least one processor 340 is in communication with the at least one sensor 330. The at least one processor 340 has a computer-readable memory and a power supply. A brightness of the at least one LED 230 is determined by a voltage condition of the at least two FCs 210, 212, 214.

Referring particularly to FIG. 2A, FCs 210, 212, and 214 are shown operating in a module. In operation, any suitable plurality of FCs may be grouped together into an operating module, although modules of 2 and 3 are specifically contemplated within this disclosure. Each FC 210, 212, 214 may include a cathode 216 and anode 218 formed by a bipolar plate (BPP) 220 which encloses a fuel cell. A gasket 222 may seal the FC at the cathode and anode 216, 218. During operation, electrical current generated by the FCs 210, 212, 214 may power the at least one LED 230.

The at least one LED 230 may be any suitable LED, and may include any suitable type, number, size, arrangement, and orientation of LEDs. The at least one LED may include any suitable wavelengths of the electromagnetic spectrum, including particularly the visible and the infrared spectra. In one particular example, at least one LED operating within the near-infrared band, around 940 nm, may be most suitable for operation. The at least one LED 230 may be in electrical communication with the FCs 210, 212, 214 by an LED circuit 232. The LED circuit 232 may include electronic components typically found in electrical circuits, including voltage limiting components, resistors, capacitors, and the like. In one example, these components may be integrated within the LEDs 230.

The electrical current generated by the FCs 210, 212, 214 may power the LED 230 under nominal operating conditions. In other words, when the FCs 210, 212, 214 are operating within normal or minimum-acceptable parameters, and therefore generating an acceptable electrical power output, the at least one LED 230 may be powered to emit light. The brightness of the emitted light, which may be measured as either the luminous intensity of the LED 230, the illuminance, or any other photometric unit that is suitable for measurement, may be dependent upon the current, and therefore, a voltage condition of the at least two FCs 210, 212, 214. When one or more of the FCs 210, 212, 214 operate at an increased voltage condition, the at least one LED 230 may emit a brighter light. When one or more of the FCs 210, 212, 214 operate at a decreased voltage condition, the at least one LED 230 may emit a dimmer light. When the FCs 210, 212, 214 operate at a voltage sufficiently less than nominal voltage, the least one LED 230 may not emit light at all. In this way, the at least one LED 230 may communicate the voltage condition of the FCs 210, 212, 214 within the module.

In one example, a single LED 230 may communicate the voltage condition for multiple FCs 210, 212, 214 within a module. This is illustrated in FIG. 3, described below. For instance, a single LED 230 may communicate the voltage condition for two or three FCs, depending on the size and nature of the module. In operation, if the total voltage generated by the FCS 210, 212, 214 within the module is sufficient to cause the LED 230 to generate an emission, then the voltage condition communicated by the LED 230 may be that of a “nominal” operating state even when individual FCs are operating below nominal voltage levels, but other FCS are operating at or above nominal voltage levels. In another example, when one or more FCs are operating at or below nominal voltage levels, the brightness of the LED 230 may be dim compared with a base or reference brightness for all FCs within the module operating at nominal conditions.

FIG. 2B is a diagrammatic illustration of the system 200 for monitoring a voltage condition of an FC stack of FIG. 2A in operation with multiple LED circuits 240-248, in accordance with the first exemplary embodiment of the present disclosure. FIG. 2B may be understood with reference to FIG. 2A, above. For simplicity of the illustration, certain reference characters are not shown in FIG. 2B. As shown in FIG. 2B, multiple FCs 210-215 are arranged together. LED circuits 240, 242, 246, 248 each having an LED are in communication with at least two FCs 210-215 as described above. Certain LED circuits may correspond to one or more particular FCs 210-215 or sets of FCs. For example, LED circuit 240 may correspond to FCs 211, 213, 215 in the lower arrangement of FCs, while LED circuit 242 may correspond to FCs 210, 212, 214 in the upper arrangement of FCs. LED circuit 244 may correspond to FCs 211, 213, 214 while LED circuit 246 may correspond to FCs 212, 214, 211. LED circuit 248 may correspond to FCs 214, 211, 213. This illustration is exemplary in nature, and the LED circuits may correspond to any number and arrangement of FCs 210-215 as desired.

In operation, certain circuits may include FCs which overlap. For example, FC 211 may be included within LED circuit 240, 244, and 248. The brightness of the LEDs 230 within LED circuits 240, 244, and 248 may communicate information concerning a voltage condition of FC 211 when the LED brightnesses are considered together. Likewise, a voltage condition of any other FC 210, 212-215 may be determined by the brightness information provided by one or more LEDs within an LED circuit 240-248 in communication with a particular FC. In another example, the voltage condition of multiple FCs, e.g. FCs 214 and 211, FCs 211 and 213, and the like, may be determined by the brightness information provided by one or more LEDs within the LED circuits 240-248.

In one example, the system 200 may include multiple LEDs 230. Each LED 230 may be connected in electrical communication across at least two FCs 210-215 operating together in series to comprise an LED circuit 240-248. Each FC 210-215 may be connected in electrical communication to at least 2 LED circuits 240-248.

FIG. 3 is a diagrammatic illustration of the system 200 for monitoring a voltage condition of an FC stack 301 of FIG. 2A in operation with an FC stack comprised of a plurality of FC modules 300, 310, 312. In the example shown in FIG. 3, three modules 300, 310, 312 are illustrated comprising the FC stack 301; however, any suitable number and arrangement of modules and FCs may be included within the FC stack 301. Each module 300, 310, 312 is shown comprising three FCs, for example 210, 212, 214. A single LED 320, 322, 324 is mounted directly on the edges of the FCs of each module 300, 310, 312. Each LED 320, 322, 324 corresponds to a module 310, 312, 300, respectively.

In operation, light emitted from the LEDs 320, 322, 324 propagates to at least one sensor 330 in visual communication with the LEDs 320, 322, 324. The at least one sensor 330 may be any suitable type, size, configuration, and number of sensors for detecting the light emitted from the LEDs 320, 322, 324, including CCD arrays, CMOS sensors, photodiode arrays, and the like. In the example discussed herein, the sensor 330 may be a camera or CCD array having a sufficient field of view to image or detect the LEDs 320, 322, 324 and tuned to detect the wavelength of light emitted by the LEDs 320, 322, 324.

The system 200 may include any additional optical components for directing, focusing, processing, or conditioning the light emitted from the LEDs 320, 322, 324. This may include prisms, lenses, filters, mirrors, waveguides, combinations thereof, and the like. The optical components may direct the light emitted from the LEDs 320, 322, 324 along any suitable path to maintain visual contact between the LEDs 320, 322, 324 and the at least one sensor 330. That is, the light from the LEDs 320, 322, 324 may propagate to the at least one sensor 330 via the additional optical components. In one example, the LEDs and/or the optical components may be sealed within the environment of the FC stack 301 so that temperature, humidity, and other environmental conditions do not interact with the other components.

The at least one sensor 330 may be in communication with at least one processor 340. The at least one processor 340 may be any suitable type, number, configuration, and arrangement of computer processors for processing and analyzing the data received by the at least one sensor 330. The at least one processor 340 may include any suitable and necessary electronic components, including a computer-readable memory and a power supply, as well as other common components such as a display, an input hardware, a network connection, and the like. The at least one processor 340 may receive the data from the at least one sensor 330 and may analyze the data to determine the voltage conditions of the FCs in the FC stack 301.

As an example, the system 200 may operate as follows: a plurality of FCs 210, 212, 214 may comprise a module 300, and a plurality of modules 300, 310, 312 may comprise an FC stack 301. The FC stack 301 may operate to generate electric power as described above. One LED 320, 322, 324 may be mounted in electrical communication to the cell edges of each module 310, 312, 300, respectively, such that each LED 320, 322, 324 is powered by and responsive to the voltage generated by each module 310, 312, 300. When a module 310 operates at nominal condition, its corresponding LED 320 may emit a beam or pulse of light, the brightness of which is dependent upon the level of voltage generated by the FCs within the module 310. In a particular example, an LED 320 may emit light at a wavelength of 940 nm when the FCs within the module 310 generate electrical power having a minimum voltage of 1.2 V or an equivalent generated voltage which has been stepped down before reaching the LED 320. If the module 310 operates to generate a voltage equal to or greater than 1.2 V, then the LED 320 may emit light on an increasingly bright scale. To prevent damage to LEDs under voltage conditions exceeding 2 V, the LED circuit may contain voltage scaling and/or limiting components. If the module 310 operates below the 1.2 V range, then the LED 320 may not emit light. All of the modules 310, 312, 300 may operate to cause their corresponding LEDs 320, 322, 324 to emit light in this manner. In another example, DC-DC converters in-line or built into LED components may increase the voltage across LEDs and allow light emission below 1.2 V. In this example, the reduction of module size is also possible to as small as one FC.

The sensor 330 may detect light emitted by the LEDs 320, 322, 324. The sensor 330 may communicate data corresponding to the light detected to the processor 340. The data may include information corresponding to the brightness, location, and timing of the light detected, among other characteristics. The processor 340 may analyze the data to determine whether each module 300, 310, 312 within the FC 301 is operating properly. One or more visual processing technologies may be used to analyze the sensor data, including machine-learning-based image segmentation models, computer vision processing, artificial intelligence detection, and the like. In one example, computer vision algorithms such as SegNet may be used to process data from a large array of FCs within an FC stack 301. In operation, such a stack may potentially include thousands of FCs 210. The visual processing technology may analyze all of the LED light data to detect and locate FCs which are performing away from nominal conditions, detect and locate anomalies within the FC stack, detect low-performance patterns within the FC, and even to predict FCs about to diverge from nominal operating conditions.

In one example, the processor 340 may determine a voltage condition for each module 300, 310, 312 within the FC stack 301. In another example, the processor 340 may determine and detect a number of modules 300, 310, 312 performing above or below a performance threshold based on the voltage condition detected. For instance, the processor 340 may be configured to record or report modules having a voltage condition below a threshold level, i.e., a brightness value as registered by the sensor 330 below a threshold detection point, or under a threshold length of time, or under other threshold conditions. The processor 340 may communicate the voltage conditions for all modules 300, 310, 312 or for modules performing below nominal conditions, or for any number and type of modules. The module information may be communicated directly through a display device in communication with the processor 340 (not shown) or by transmitting the information across at least one network connection, for instance, over a local network, the Internet, a wireless network, or other communications network. A user may receive the information and may take steps to adjust the performance of one or more FCs 210, 212, 214 in response. In another example, the processor 340 may be configured to automatically or directly adjust the performance of one or more FCs 210, 212, 214 responsive to the determined voltage without requiring user input. For instance, the processor 340 may be configured to downregulate one or more FCs 210, 212, 214 operating above a particular operating value, or upregulate one or more FCs 210, 212, 214 operating below a particular operating value. The processor 340 may be configured to control the operation of the FCs 210, 212, 214 at one or more points in time and according to one or more parameters in order to adjust the performance of the FCs 210, 212, 214. In one example, the processor 340 may communicate the identified FCs 210, 212, 214 to a user and act to automatically or directly adjust the performance of the one or more FCs 210, 212, 214. In one example, an output of the FCs 210, 212, 214 may be reduced or terminated. In another example, the output of individual FCs may be reduced or terminated, one by one, until one FC responsible for causing the voltage condition has been identified.

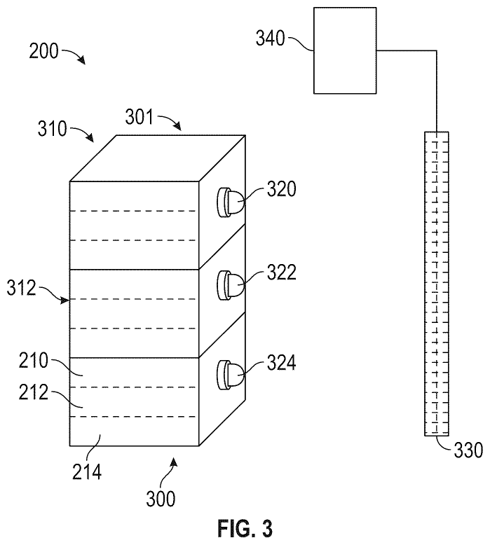

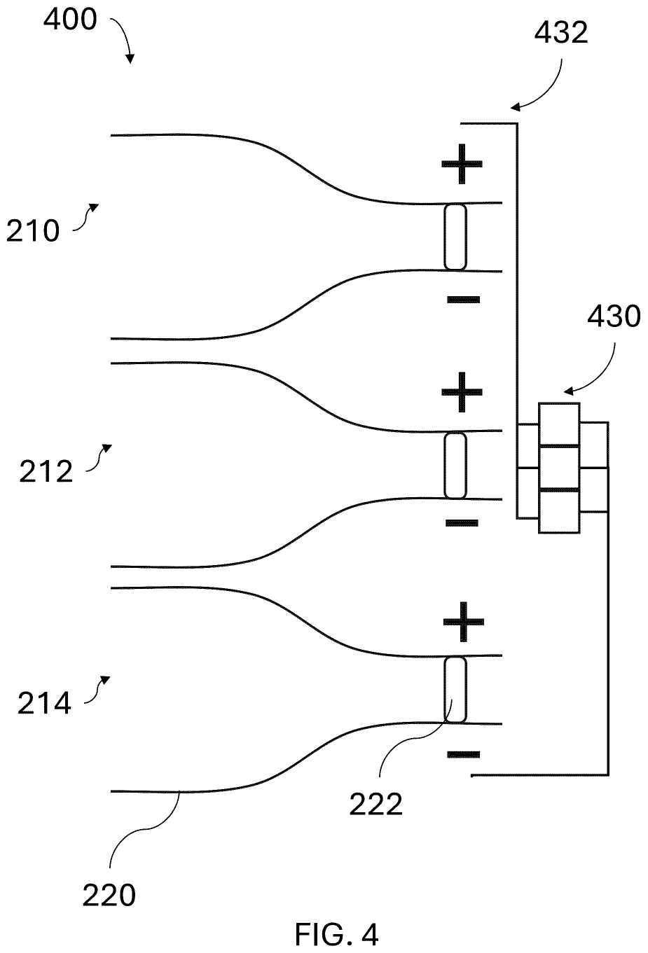

FIGS. 4-5 are diagrammatic illustrations of the system 400 for monitoring a voltage condition of an FC stack using multiple LEDs 430, in electrical communication with the FCs 210, 212, 214 by an LED circuit 432 in accordance with the first exemplary embodiment of the present disclosure. FIG. 4 illustrates a portion of the system 400 that includes the FC components and the LED emitter components. FIG. 5 illustrates a portion of the system 400 that includes the FC components in operation as an FC stack 301, along with the sensor 330 and processor 340 to receive the voltage condition information. FIGS. 4 and 5 may be understood with reference to FIGS. 2A-3 above. The system is denoted with reference character 400 to distinguish its use of multiple LEDs 430, 520, 522, 524 from the system 200's use of singular LEDs; otherwise, the components illustrated herein are the same as in FIGS. 2A-3.

In FIG. 4, multiple LEDs 430 are shown wired to the FCs 210, 212, 214 in parallel, creating an LED circuit 432 having a plurality of branches. Each branch of this LED circuit 432 may have a different resistance such that a different voltage condition from the FCs 210, 212, 214 is required to cause each LED to emit light. For example, a first LED branch within the multiple LED circuit 432 may have a first resistance and may require a first voltage condition to cause emission. A second LED branch within the multiple LED circuit 432 may have a second resistance different from the first LED branch. The second resistance may be greater than the first resistance and may require a second, higher voltage condition to cause emission from the second LED. A third LED branch within the multiple LED circuit 432 may have a third resistance different from the first and second LED branches. The third resistance may be greater than the first and second resistance and may require a third, higher voltage condition to cause emission from the third LED. This may continue for as many LEDs as are contained within the multiple LEDs. In one example, resistors in series with each LED may be used to create branches with an increasing turn-on voltage. In another example, LEDs with different internal resistance or turn on voltage may be used to create branches with an increasing turn-on voltage.

The multiple LEDs may be any suitable type, nature, and number of LEDs, and may include diode bars, brackets, arrays, and the like. In one example, voltage limiting components such as Zener diodes may be included in series with the LEDs. In another example, voltage information may be transmitted either continuously or on a periodic cycle controlled by a timing circuit or logic components.

FIG. 5 is a diagrammatic illustration of the system 400 for monitoring a voltage condition of an FC stack using multiple LEDs in operation with an FC stack 301, in accordance with the first exemplary embodiment of the present disclosure. FIG. 5 shows three modules 310, 312, 300 of FCs 210, 212, 214 in operation as an example. As illustrated in FIG. 5, each module 310, 312, 300 may have a linear array of multiple LEDs 520, 522, 524, respectively mounted to the edges of the module 310, 312, 300. The placement, position, orientation, size, shape, and arrangement of the multiple LEDs 520, 522, 524 may be of any suitable nature, depending on the FC stack 301, the LEDs 520, 522, 524, the sensor 330, and the optical environment.

As described above, in one example, the multiple LED circuit branches 520, 522, 524 may have different resistance characteristics so as to require different, increasing voltage levels in order to cause emittance of the diode. This may allow the processor 340 to easily identify when particular voltage levels are in effect, depending on which diodes are emitting light upon the sensor 330. In another example, the multiple LEDs 520, 522, 524 may have different characteristics in order to indicate the voltage levels. For instance, a first LED may have a first maximum brightness, while a second LED may have a second maximum brightness higher than the first maximum brightness. A first LED may have a first wavelength, while a second LED may have a second wavelength different than the first wavelength. A first LED may be located in one position on the edge of the FC, while a second LED may be located at a second, different position on the edge of the FC. A third LED may have a third, different characteristic which differentiates it from the first and second LED, and so on. The resistance required to engage emission of the subsequent LEDs may be progressively higher, as described above, in order to identify the successive voltage levels in operation by the FCs. However, these differentiating characteristics may provide multiple ways for the detector and the processor to easily identify voltage levels within each module 310, 312, 300.

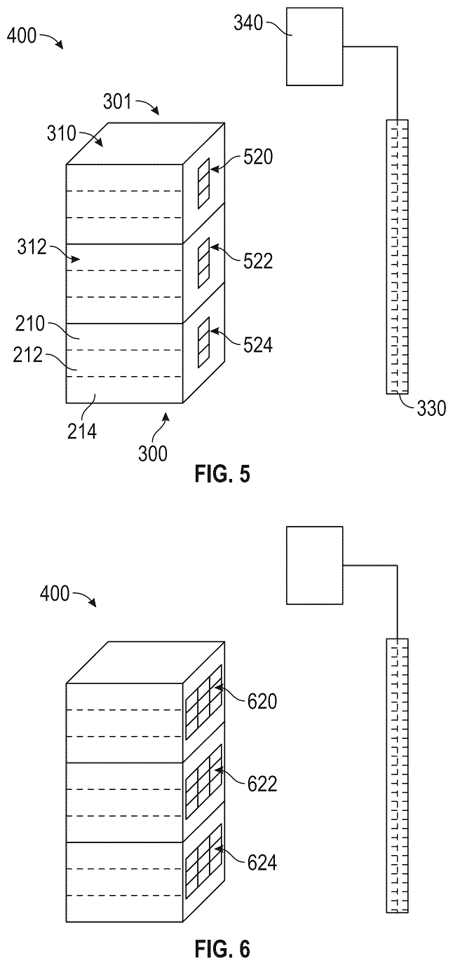

FIG. 6 is a diagrammatic illustration of the system 400 for monitoring a voltage condition of an FC stack 301 using LED arrays 620, 622, 624, in accordance with the first exemplary embodiment of the present disclosure. FIG. 6 may be understood with reference to FIGS. 2A-5, above, and may include the same component aspects illustrated therein. For simplicity in the illustration, reference characters for aspects shown in FIG. 6 which have been previously referenced, including the FC stack 301, the modules 300, 310, 312, the FCs 210, 212, 214, the at least one sensor 330, and the at least one processor 340 are not shown in the drawing.

As illustrated in FIG. 6, each module 310, 312, 300 may include a two-dimensional array of LEDs 620, 622, 624, respectively, mounted directly on the FC edges. In one example, the arrays 620, 622, 624 may include LEDs having multiple, different resistance properties, brightness properties, or color and wavelength properties, as described above. In another example, individual LEDs within the arrays 620, 622, 624 may be in electrical communication with individual FCs or a unique combination of FCs, thereby allowing those particular LEDs to communicate voltage conditions of individual FCs at a granular level. In another example, other LEDs may be configured with logic components or connected with additional sensors to indicate additional system conditions relevant to the FCs or the modules 310, 312, 300. For instance, a first column of LEDs may indicate stepped voltage levels generated by a module 310, as described above relative to FIG. 5. A second column of LEDs may indicate the real-time voltage of each individual FC within the module 310. A third column of LEDs may indicate whether the module voltage is increasing, decreasing, operating within optimal velocity conditions, whether the voltage has been above or below a threshold value, and the like. In another example, LEDs may be in communication with additional sensor components 14 to indicate the temperature, chemical environment, or other metric. Any suitable number of rows and columns of LEDs may be included within the LED arrays 620, 622, 624, and any number and type of voltage or other relevant conditions may be communicated. In this way, the at least one sensor 330 may receive light emissions from the LED arrays 620, 622, 624 and may thereby receive one or more types of information concerning the system conditions of the FC stack 301. In one example, when an LED indicating an increasing or decreasing voltage within a module begins emitting, the at least one sensor 330 may detect the light from the LED, the processor 340 may determine the voltage condition of the module 310, and the processor 340 may be configured to monitor the module 310 more closely to determine whether the anomalous voltage condition is persisting. In one example, the processor 340 may be configured to monitor the LEDs communicating the real-time voltage conditions of individual FCs to determine if one or more particular FCs is causing the non-nominal operating condition.

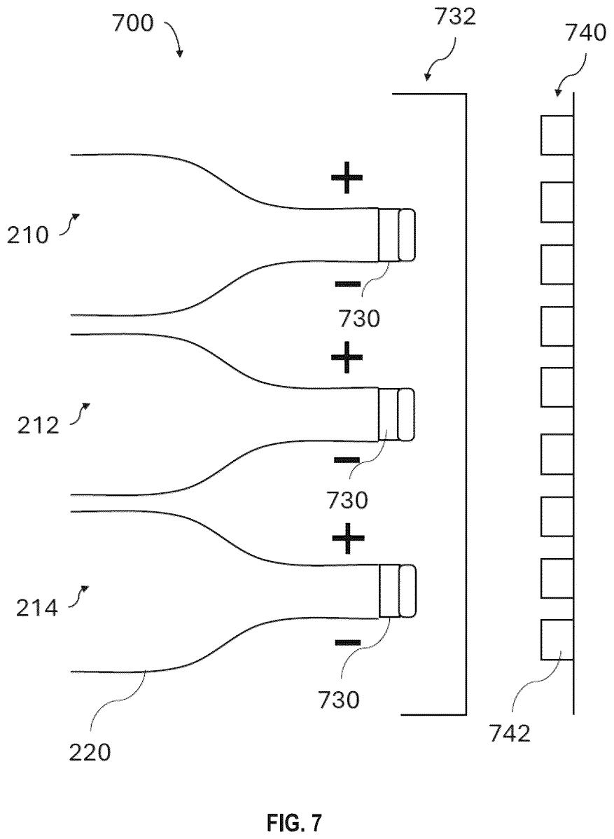

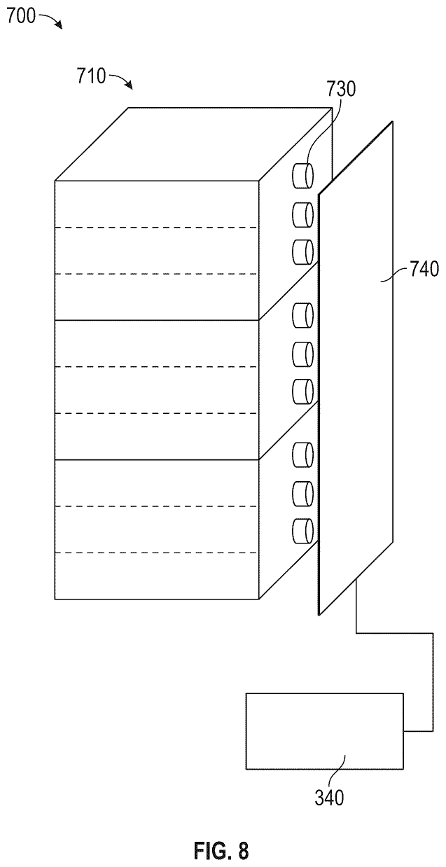

FIGS. 7-8 are diagrammatic illustrations of a system for monitoring a voltage condition of an FC stack (“system”) 700 using acoustic transducers 730, in accordance with a second exemplary embodiment of the present disclosure. FIG. 7 illustrates a portion of the system 700 that includes the FC components and the emitting acoustic transducer components. FIG. 8 illustrates a portion of the system 700 that includes the FC components in operation as an FC stack 710, along with an acoustic detection array 740 and processor 340 to receive the voltage condition information. At least one FC 210, 212, 214 is operated, individually or together in series. At least one emitting acoustic transducer 730 is in electrical communication with the at least one FC 210, 212, 214. At least one receiving acoustic sensor 742 is in audio communication with the at least one emitting acoustic transducer 730 to receive an acoustic emission from the at least one emitting acoustic transducer 730. These receiving sensors may be acoustic transducers or other acoustic sensing technologies. At least one processor 340 is in communication with the at least one receiving acoustic sensor 742. The at least one processor 340 has a computer-readable memory and a power supply. An intensity or frequency of the acoustic emission from the at least one emitting acoustic transducer 730 is responsive to a voltage condition of the at least one FC 210, 212, 214.

Referring particularly to FIG. 7, the FCs 210, 212, 214 of FIG. 2A are shown. As an example, FIG. 7 shows three FCs 210, 212, 214 operating together in series. However, it should be understood that any number of FCs, including a single FC 210, may be used in operation with the system 700. At an edge of each FC 210, 212, 214 is mounted an emitting acoustic transducer 730 in electrical communication with each FC 210, 212, 214 individually. The emitting acoustic transducers 730 may be any suitable number, size, type, and arrangement of acoustic emitters. In one example, this may include acoustic emitters in the ultrasonic range of about 1-100 MHz, which may maximize the prominence of an emitted signal over the background noise generated by the FC stack environment. For instance, piezoelectric ultrasound transducers, which operate via AC bias across electrodes, and capacitive micromachined ultrasonic transducers, which operate via DC bias and an applied AC bias matching desired emission frequency, may be suitable. In another example, any suitable acoustic range, including signals within the human sonic range of 20 Hz-20,000 Hz, may also be used. In another example, noise filters, environmental seals, and other acoustic components may be used to direct, condition, focus, and improve the quality of the acoustic signal. In one example, the emitting acoustic transducers 730 and the FCs 210, 212, 214 may be sealed within a mechanical enclosure 732 to reduce noise and other environmental conditions.

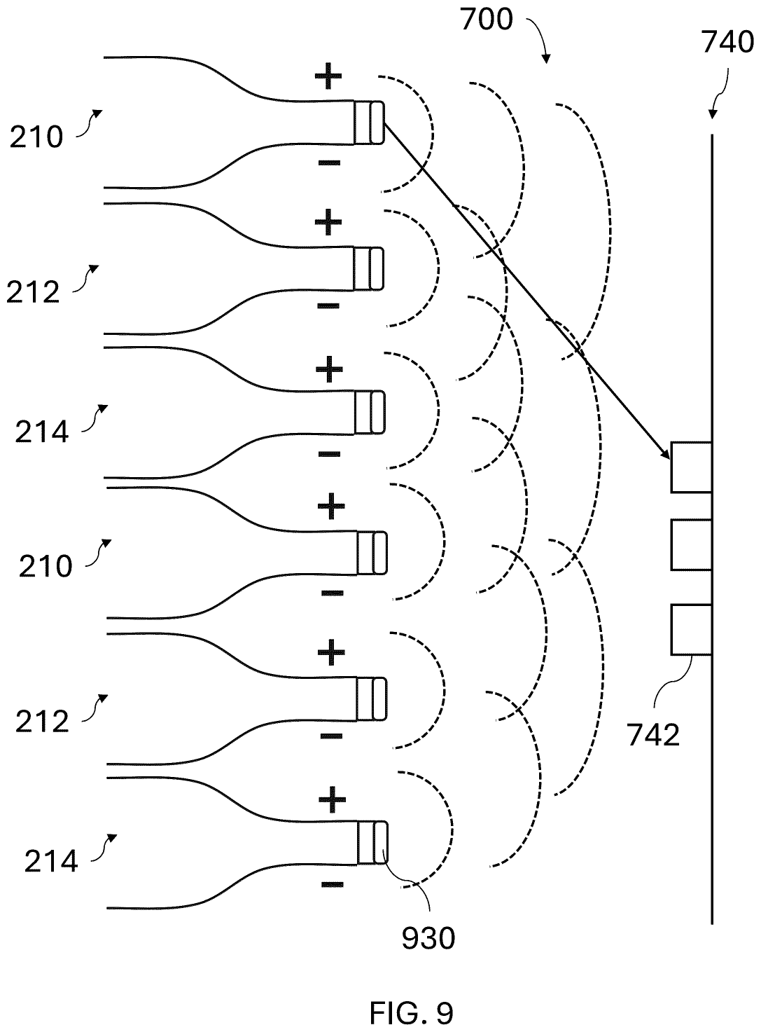

At least one receiving acoustic sensor 742 is in audio communication with the at least one emitting acoustic transducer 730 to receive an acoustic emission from the at least one emitting acoustic transducer 730. The at least one receiving acoustic sensor 742 may be any suitable type, number, configuration, orientation, and arrangement of acoustic receivers capable of receiving the acoustic signal or signals generated by the emitting acoustic transducers 730. In the example shown in FIGS. 7-8, a two-dimensional linear receiver array is indicated in order to cover the field of view of the entire FC stack 710. This may allow precise localization of the intensity maximum of any given received signals and detection of the corresponding origination cell. In another example, localization may be performed by comparing the signal time of arrival (ToA) at different receiving acoustic sensors 742 within the acoustic detection array 740. In another example, localization may be performed by assigning each emitting acoustic transducer 730 a unique frequency within the ultrasonic range. However, other arrangements are contemplated within the scope of this disclosure. For instance, two or more emitting acoustic transducers 730 may operate as a phased-array with emissions timed to perform phase-steering. This arrangement may cause the emitted acoustic waveforms to interact coherently to generate interference patterns that effectively (1) steer emissions toward a small acoustic detection array 740 of only a few receiving acoustic sensors 742, and/or (2) encode additional information such as: originating cell, temperature, and the like. This is discussed in greater detail with respect to FIG. 9, below.

In operation, when an FC 210 generates electric power, the electric power may be configured to directly drive the emitting acoustic transducer 730 to emit an acoustic signal. In one example, a DC-AC converter may be used to drive the operation of piezoelectric ultrasonic transducers. The amplitude of the generated acoustic waves may correspond with a voltage condition of the FC 210. In another example, onboard logic components may allow the tuning of AC voltage frequency, permitting the selection of an ultrasonic frequency distinct from environmental background noise.

FIG. 8 is a diagrammatic illustration of the system 700 in operation with an FC stack 710, in accordance with the second exemplary embodiment of the present disclosure. As shown in FIG. 8, the FC stack 710 comprises a plurality of individual FCs 210, 212, 214 in operation together. Emitting acoustic transducers 730 may be mounted to the edges of each FC within the stack 710 to generate an acoustic signal corresponding to each FC within the stack 710. In another example, a modular design may be used with one acoustic transducer for two or more FCs. The at least one receiving acoustic sensor, which is shown as a linear acoustic detection array 740, may be in audio communication with the emitting acoustic transducers 730. This may be understood to mean that the acoustic detection array 740 can receive acoustic signals emitted by the emitting acoustic transducers 730. FIG. 8 shows the acoustic detection array 740 spaced apart from the FC stack 710. This is for clarity of illustration. In operation, the receiving acoustic sensors 742 may be located at any suitable distance for receiving the emitted acoustic signals and may be enclosed within the mechanical enclosure 732, separate from the mechanical enclosure 732, enclosed within a separate enclosure, or otherwise positioned and oriented to receive the emitted acoustic signals.

The received acoustic signals may be processed as data by the at least one processor 340. The at least one processor may be configured to determine a voltage condition of the FCs by determining an acoustic intensity of the received acoustic signal and determining an FC source of the acoustic signal. As described above relative to FIGS. 2A-7, the processor 340 may be configured to analyze thousands of emitted signals pertaining to thousands of individual FCs and may do so by way of any suitable analytical techniques described herein. In particular, machine learning algorithms developed for the processing of acoustic signal data and artificial intelligence methods may be employed to classify the voltage condition of each FC within the FC stack 710. In one example, the processor 340 may determine whether each of the received acoustic signals corresponds to an FC operating within a threshold range of voltage values considered nominal for the FC stack 710. If any FCs are determined to be outside of the range, then the processor 340 may be configured to communicate this result to a user. If the processor 340 determines that particular FCs are trending outside of the nominal operating range, an alert may be communicated to the user. In one example, the processor 340 may be configured to directly or automatically adjust the performance of one of more FCs 210, 212, 214 responsive to the determined voltage without requiring user input. The determination may include identifying the individual FC which has deviated or is likely to deviate from the nominal operating value or range.

In one example, the processor 340 may analyze other characteristics of the received acoustic emissions rather than or in addition to the intensity, such as the frequency of the acoustic emissions. For instance, each emitting acoustic transducer 730 may emit an acoustic signal with a frequency that varies depending on the voltage characteristic of the corresponding FC 210, 212, 214. If the voltage characteristic falls away from a nominal range, the frequency of the acoustic emission may become greater or lesser than typical, i.e., outside a desired range. The receiving acoustic transducers 742 may receive this emission and the processor 340 may determine, based on the frequency, that one or more FCs 210, 212, 214 is operating at a given voltage characteristic point.

FIG. 9 is a diagrammatic illustration of the system 700 for monitoring a voltage condition of an FC stack using acoustic transducers in a phase-steering operational mode, in accordance with the second exemplary embodiment of the present disclosure. FIG. 9 may be understood with reference to FIGS. 2A-8 above, and particularly with reference to FIGS. 7-8. FIG. 9 illustrates a particular configuration of emitting acoustic transducers 930 and receiving acoustic sensors 742 in a phased-array acoustic detection array 740, which may enable the use of a limited, localized number of receiving acoustic sensors 742 in operation with the system. The emitting acoustic transducers 930 may be any of the transducers described above with additional logic components that delay or otherwise time the emission of the acoustic signal from two or more emitting transducers across the FC stack 710. The signals from transducers on multiple FCs 210, 212 may be emitted to create coherent interference of the soundwaves, which may cause a strengthened signal to appear to travel in a non-orthogonal direction toward the receiving acoustic sensors 742 on the acoustic detection array 740. The result is that the constructive super-signal may provide the receiving acoustic sensors 742 with voltage condition data for even FCs 210 which are spatially located at a distance away from the acoustic detection array 740. In another example, the generated interference patterns allow the encoding of additional information onto the sound waveform, which may include FC temperature, chemical environment, among others.

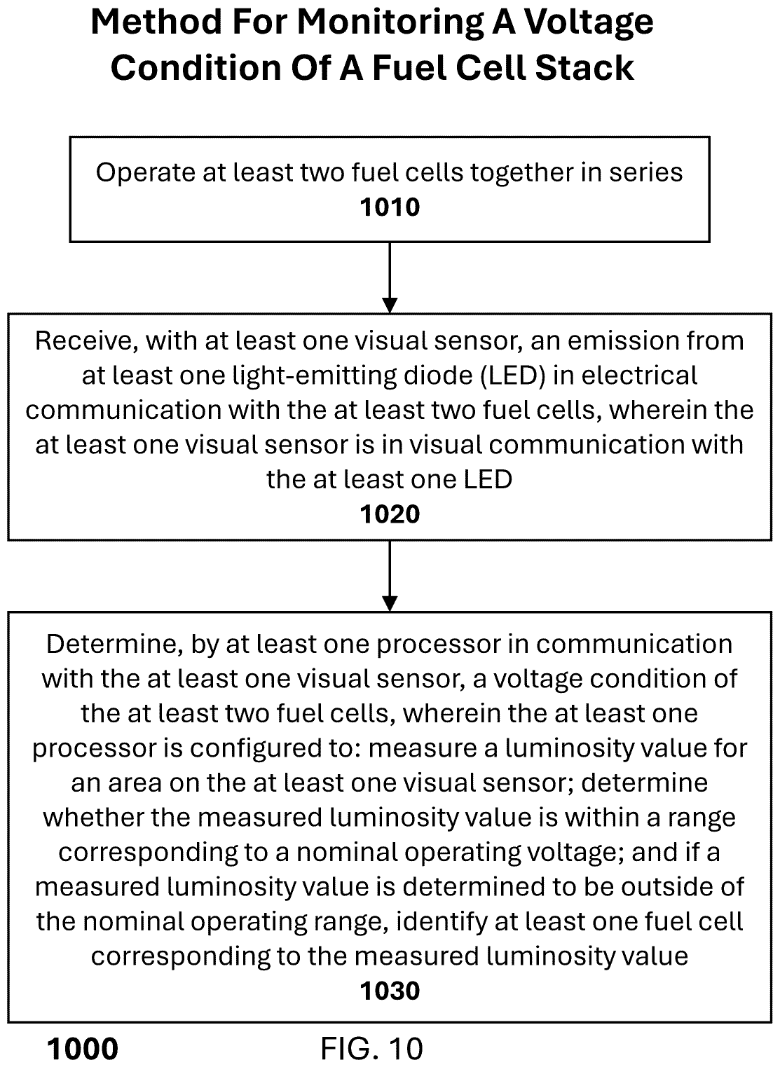

FIG. 10 is a flow chart 1000 illustrating a method for monitoring a voltage condition of an FC stack using LEDs, in accordance with the first exemplary embodiment of the present disclosure. FIG. 10 may be understood with reference to FIGS. 2-9, above, and may include any of the component aspects described above therein.

Step 1010 includes operating at least two FCs together in series. In one example, two FCs may be operated together in series as a module. In another example, three FCs may be operated together as a module. In yet another example, any other suitable number of FCs may be operated together, depending on the FCs and the other hardware components used.

Step 1020 includes receiving, with at least one visual sensor, an emission from at least one light-emitting diode (LED) in electrical communication with the at least two FCs, wherein the at least one visual sensor is in visual communication with the at least one LED. The emission or plurality of emissions may be as described relative to FIGS. 2A-9, above, and may correspond to the voltage conditions of the FCs with which they are in electrical communication. The visual sensor may receive the emissions based on a location of the emissions upon the sensor, i.e., all of the emissions may strike the sensor in a different location upon the sensor face corresponding to the location of the LEDs. In another example, the emissions of the LEDs may be timed such that the sensor receives the emissions in a temporal order rather than a positional order.

Step 1030 includes determining, by at least one processor in communication with the at least one visual sensor, a voltage condition of the at least two FCs, wherein the at least one processor is configured to: measure a luminosity value for an area on the at least one visual sensor; determine whether the measured luminosity value is within a range corresponding to a nominal operating voltage; and if a measured luminosity value is determined to be outside of the nominal operating range, identify at least one FC corresponding to the measured luminosity value. The luminosity value may correspond to a brightness of an LED upon the sensor. As described above, a threshold brightness value may indicate an FC is operating within a nominal operating parameter. A brightness value within a nominal range may indicate that a voltage of an FC module is within nominal voltage range. The processor may compare the measured luminosity value in real-time, at periodic points in time, or as often as needed to monitor FC modules which appear to be approaching the limits of the nominal range. The processor may use any of the visual processing methods described above to identify at least one FC corresponding to the measured luminosity value. In the case of multiple FCs within an FC module, the processor may use methods to determine which of the individual FCs comprising the FC module is causing the voltage condition to become poor. Alternatively, the processor may indicate that an entire module is reporting suboptimal performance.

In another example, LEDs may be in communication with additional sensor components to indicate the temperature, chemical environment, or other metric. In such an example, the LEDs may be in electrical communication with one or more additional sensor components located within or about the FCs. For instance, temperature sensors 14, chemical environment sensors, or other sensors may be in electrical communication with LEDs such that sensor data from those sensors may be encoded into an emission from the LEDs to be received by the visual sensor. The processor may be configured to determine a temperature condition and/or a chemical environment condition based on the luminosity values encoded into the LED transmission. In one example, the absolute luminosity of the LED may communicate the temperature or chemical environment condition to the processor. In another example, the conditions may be encoded in pulse length, duration, timing, or the like. In this way, voltage condition information and other condition information may be communicated simultaneously.

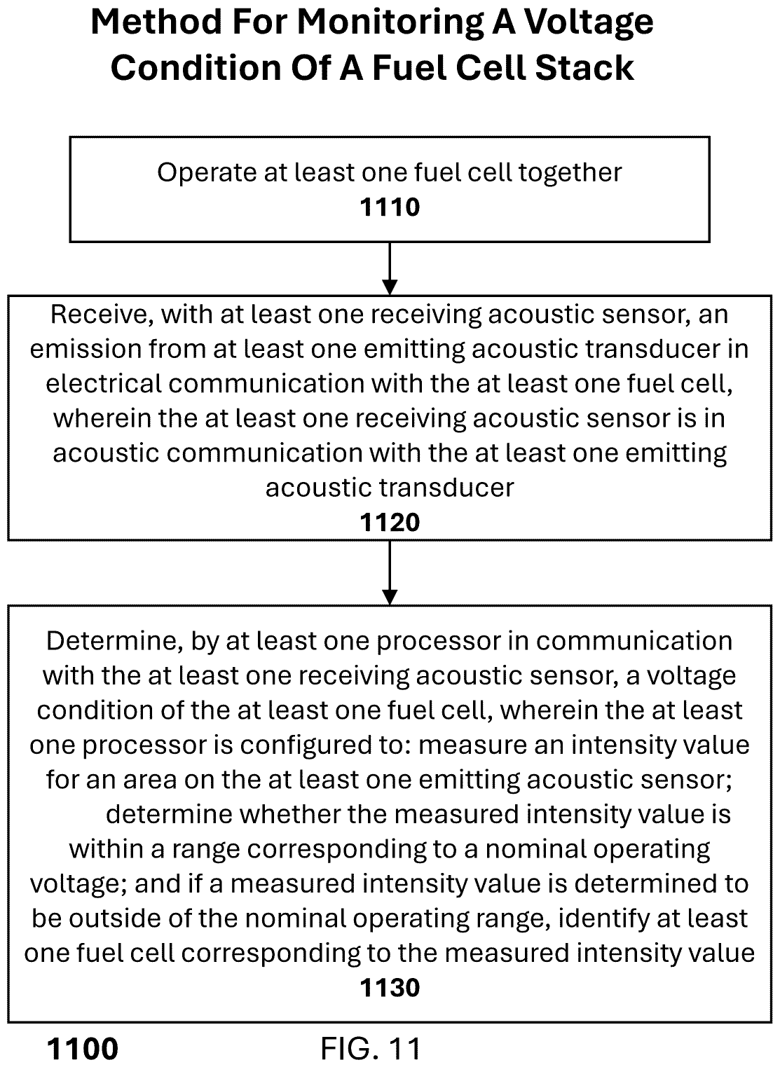

FIG. 11 is a flow chart 1100 illustrating a method for monitoring a voltage condition of an FC stack using acoustic transducers, in accordance with the second exemplary embodiment of the present disclosure. FIG. 11 may be understood with reference to FIGS. 2A-10, above.

Step 1110 includes operating at least one FC together. In one example, a small number of FCs may be grouped together into modules of two or three, or any desired number.

Step 1120 includes receiving, with at least one receiving acoustic sensor, an emission from at least one emitting acoustic transducer in electrical communication with the at least one FC, wherein the at least one receiving acoustic sensor is in acoustic communication with the at least one emitting acoustic transducer.

Step 1130 includes determining, by at least one processor in communication with the at least one receiving acoustic sensor, a voltage condition of the at least one FC, wherein the at least one processor is configured to: measure an intensity value for an area on the at least one emitting acoustic sensor; determine whether the measured intensity value is within a range corresponding to a nominal operating voltage; and if a measured intensity value is determined to be outside of the nominal operating range, identify at least one FC corresponding to the measured intensity value. In one example, the measured intensity value may be considered along with additional values, such as phase characteristics of the acoustic signal, to separate the intensity information encoded into a phased-array detection array, as described relative to FIG. 9.

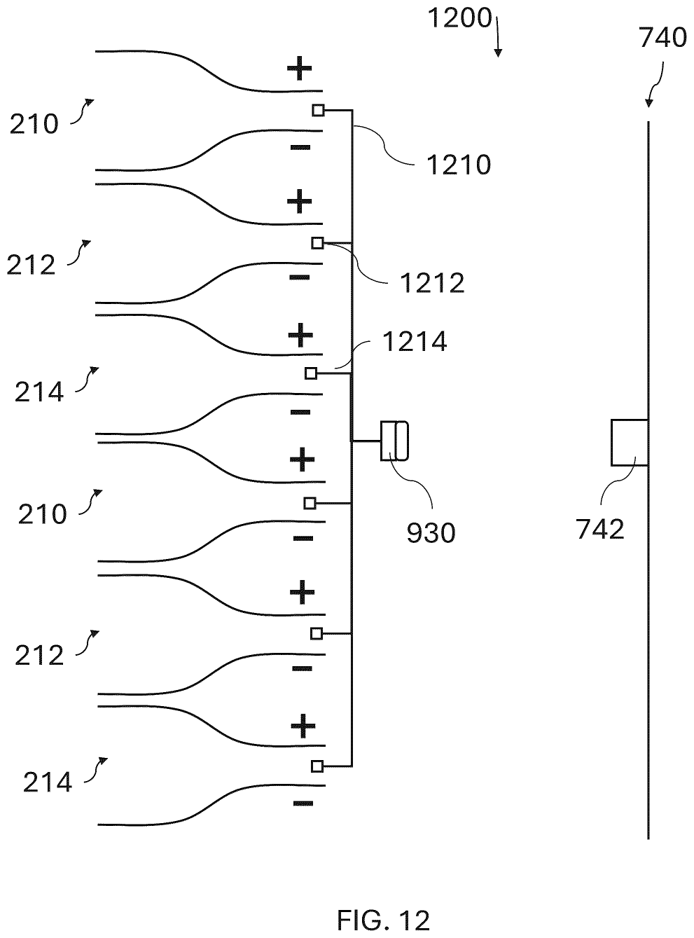

FIG. 12 is a diagrammatic illustration of a system 1200 for monitoring a voltage condition of an FC stack using acoustic transducers 930, in accordance with the second exemplary embodiment of the present disclosure. FIG. 12 may be understood with reference to FIGS. 2A-11, above, and with particular reference to FIGS. 7 and 9. As shown in FIG. 12, the system 1200 includes fewer emitting acoustic transducers 930 than are shown in FIGS. 7 and 9. In this example, a single emitting acoustic transducer 930 is shown, although any number of acoustic transducers 930 may be used. The system 1200 may include fewer emitting acoustic transducers 930 than FCs such that multiple FCs 210, 212, 214 are in communication with an emitting acoustic transducer 930. In one example, all FCs 210, 212, 214 within an FC stack may be in communication with a single emitting acoustic transducer 930. In another example, a plurality emitting acoustic transducers 930, less than the total number of FCs may be used.

In operation, the acoustic emission or emissions made by the emitting acoustic transducer 930 may be timed so as to communicate a voltage condition or other FC information about each FC 210, 212, 214 in turn. For instance, FC 210 shown at the top of FIG. 12 may generate voltage condition information along circuit 1210, which may be emitted first by emitting acoustic transducer 930. FC 212, just below, may generate voltage condition information along circuit 1212, which may be emitted second by emitting acoustic transducer 930. FC 214, just below, may generate voltage condition information along circuit 1214, which may be emitted third by emitting acoustic transducer 930. This may continue for each FC in turn and may repeat periodically. At least one receiving acoustic sensor 742 may be in audio communication with the emitting acoustic transducer 730 to receive the emissions. The received emissions may be communicated to a processor 340 and processed as described herein.

The frequency and periodicity of each acoustic emission may depend upon the system 1200. In one example, each individual FC 210 may communicate voltage condition or other information at periodic intervals for transmission. In another example, certain FCs 210 communicating voltage conditions outside of nominal operating conditions may be directed to communicate more frequently until the operating condition has returned to a nominal state. In another example, the number of emitting acoustic transducers 730 may be determined by the desired frequency of acoustic emissions and the number of FCs 210, 212, 214 within the FC stack.

In one example, emitting acoustic transducers 930 may be mounted across more than one FC 210 to create a module design. Within this module, additional logic components may allow the corresponding one or more acoustic transducers to communicate the voltage information of each cell in the module successively.

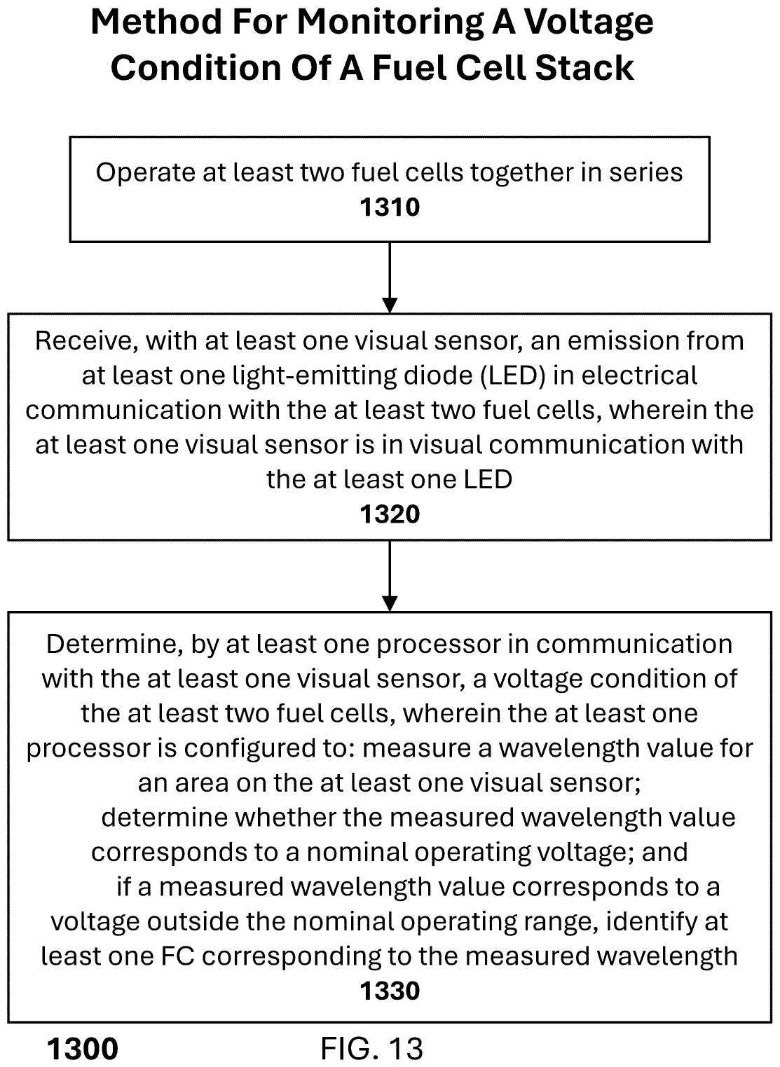

FIG. 13 is a flow chart 1300 illustrating a method for monitoring a voltage condition of an FC stack using acoustic transducers, in accordance with the second exemplary embodiment of the present disclosure. FIG. 13 may be understood with reference to FIGS. 2A-12, above, and with particular reference to FIGS. 3 and 5.

Step 1310 includes operating at least two FCs together in series.

Step 1320 includes receiving, with at least one visual sensor, an emission from at least one light-emitting diode (LED) in electrical communication with the at least two FCs, wherein the at least one visual sensor is in visual communication with the at least one LED.

Step 1330 includes determining, by at least one processor in communication with the at least one visual sensor, a voltage condition of the at least two FCs, wherein the at least one processor is configured to: measure a wavelength value for an area on the at least one visual sensor; determine whether the measured wavelength value corresponds to a nominal operating voltage; and if a measured wavelength value corresponds to a voltage outside the nominal operating range, identify at least one FC corresponding to the measured wavelength.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

### LIST OF REFERENCES

12 FC
14 temperature sensor
16 current sensor
18 CVM acquisition hardware
200 system
210, 211, 212, 213, 214 215 FCs
216 cathode
218 anode
220 bipolar plate
222 gasket
230 LED
232, 240, 242, 244, 246, 248 LED circuit
300, 310, 312 modules
301 FC stack
320, 322, 324 LED
330 sensor
340 processor
400 system
430 multiple LEDs
432 LED circuit
520, 522, 524 LEDs
620, 622, 624 LED arrays
700 system
710 FC stack
730 transducer
732 mechanical enclosure
740 acoustic detection array
742 receiving acoustic sensor
930 emitting acoustic transducer
1000-1030 flow chart and steps
1100-1130 flow chart and steps
1200 system
1210-1214 circuits
1310-1330 flow chart and steps

What is claimed:

1. A system for monitoring a voltage condition of a fuel cell (FC) stack, comprising:
at least two FCs operating together in series;
at least one light-emitting diode (LED) in electrical communication with the at least two FCs;
at least one sensor in visual communication with the at least one LED to receive a visual emission from the at least one LED; and
at least one processor in communication with the at least one sensor, the at least one processor having a computer-readable memory and a power supply,
wherein a brightness of the at least one LED is determined by a voltage condition of the at least two FCs.

2. The system of claim 1, wherein the at least two FCs operating together in series form an FC module, wherein each FC module consists of two or more FCs, and wherein the system comprises a plurality of FC modules.

3. The system of claim 2, wherein the at least one LED is one LED corresponding to each FC module.

4. The system of claim 1, wherein the at least one LED is a plurality of LEDs, wherein each LED in the plurality of LEDs is connected across at least two FCs operating together in series to comprise an LED circuit, and wherein each FC is connected to at least 2 LED circuits.

5. The system of claim 1, wherein the at least one LED is a plurality of LEDs, wherein a circuit branch containing each LED has a resistance property different from a circuit branch containing each other LED, and whereby each LED is activated to emit light under a different voltage condition than each other LED.

6. The system of claim 5, wherein a first circuit branch has a first resistance property requiring a first voltage condition to cause emission of the first LED, and wherein a second circuit branch has a second resistance property requiring a second voltage condition greater than the first voltage condition to cause emission of the first LED.

7. The system of claim 1, wherein the at least one LED is a plurality of LEDs, wherein the plurality of LEDs has a plurality of emission wavelengths to communicate differences in at least one from the set of: a voltage, a voltage velocity, a voltage above a threshold value, a voltage below a threshold value, and a physical location.

8. The system of claim 1, wherein the visual emission from the at least one LED is emitted on a periodic cycle.

9. The system of claim 1, further comprising at least one DC-DC converter in electrical communication with the at least one LED.

10. A system for monitoring a voltage condition of a fuel cell (FC) stack, comprising:
at least one FC;
at least one emitting acoustic transducer in electrical communication with the at least one FC;
at least one receiving acoustic sensor in audio communication with the at least one emitting acoustic transducer to receive an acoustic emission from the at least one emitting acoustic transducer; and
at least one processor in communication with the at least one receiving acoustic sensor, the at least one processor having a computer-readable memory and a power supply,
wherein an intensity or frequency of the acoustic emission from the at least one emitting acoustic transducer is responsive to a voltage condition of the at least one FC.

11. The system of claim 10, wherein the at least one emitting acoustic transducer is one emitting acoustic transducer corresponding to a plurality of FCs.

12. The system of claim 10, wherein the at least one emitting acoustic transducer emits a signal in the ultrasonic range between 1 and 100 MHz.

13. The system of claim 10, wherein the at least one FC and the at least one emitting acoustic transducer are enclosed within a mechanical enclosure.

14. The system of claim 10, wherein the at least one receiving acoustic sensor is a linear array of receiving acoustic sensors.

15. The system of claim 14, wherein at least one receiving acoustic sensor corresponds to each emitting acoustic transducer.

16. The system of claim 10, wherein the acoustic emission of at least two emitting acoustic transducers is timed to direct an interference signal to the at least one receiving acoustic sensor.

17. A method for monitoring a voltage condition of a fuel cell (FC) stack, comprising the following steps:
operating at least two FCs together in series;
receiving, with at least one visual sensor, an emission from at least one light-emitting diode (LED) in electrical communication with the at least two FCs, wherein the at least one visual sensor is in visual communication with the at least one LED; and
determining, by at least one processor in communication with the at least one visual sensor, a voltage condition of the at least two FCs, wherein the at least one processor is configured to:
measure a luminosity value for an area on the at least one visual sensor;
determine whether the measured luminosity value is within a range corresponding to a nominal operating voltage; and
if a measured luminosity value is determined to be outside of the nominal operating range, identify at least one FC corresponding to the measured luminosity value.

18. The method of claim 17, wherein the determination of the voltage condition is made using at least one from the set of: machine-learning-based image segmentation models, computer vision processing, and artificial intelligence detection.

19. The method of claim 17, wherein the processor is further configured to perform at least one from the set of:
communicate the identified at least one FC to a user in order to adjust the at least one FC output, and
automatically adjust the at least one FC output.

20. The method of claim 17, further comprising the steps of:
receiving with the at least one visual sensor, an emission from the at least one LED in electrical communication with an additional sensor component of the at least two FCs; and
determining, by the at least one processor, at least one from the set of: a temperature condition and a chemical environment condition of the at least two FCs, wherein the at least one processor is configured to:
measure a luminosity value for an area on the at least one visual sensor;
correlate the measured luminosity value to a temperature condition value or a chemical environment condition value; and
identify at least one FC corresponding to the measured luminosity value.

21. A method for monitoring a voltage condition of a fuel cell (FC) stack, comprising the following steps:
operating at least two FCs together in series;
receiving, with at least one visual sensor, an emission from at least one light-emitting diode (LED) in electrical communication with the at least two FCs, wherein the at least one visual sensor is in visual communication with the at least one LED; and
determining, by at least one processor in communication with the at least one visual sensor, a voltage condition of the at least two FCs, wherein the at least one processor is configured to:
measure a wavelength value for an area on the at least one visual sensor;
determine whether the measured wavelength value corresponds to a nominal operating voltage; and
if a measured wavelength value corresponds to a voltage outside the nominal operating range, identify at least one FC corresponding to the measured wavelength.

22. A method for monitoring a voltage condition of a fuel cell (FC) stack, comprising the following steps:
operating at least one FC;
receiving, with at least one receiving acoustic sensor, an emission from at least one emitting acoustic transducer in electrical communication with the at least one FC, wherein the at least one receiving acoustic sensor is in acoustic communication with the at least one emitting acoustic transducer; and
determining, by at least one processor in communication with the at least one receiving acoustic sensor, a voltage condition of the at least one FC, wherein the at least one processor is configured to:
measure an intensity value for an area on the at least one receiving acoustic sensor;
determine whether the measured intensity value is within a range corresponding to a nominal operating voltage; and
if a measured intensity value is determined to be outside of the nominal operating range, identify at least one FC corresponding to the measured intensity value.

23. The method of claim 22, wherein the determination of the voltage condition is made by analyzing a phase characteristic of the emission from the at least one emitting acoustic transducer.

24. The method of claim 22, wherein the step of identifying at least one FC corresponding to the measured intensity value is performed by analyzing a time of signal arrival to the at least one receiving acoustic sensor.

25. The method of claim 22, wherein the step of determining a voltage condition is made by measuring a frequency of the emission from the at least one emitting acoustic transducer.

26. The method of claim 22, wherein the processor is further configured to perform at least one from the set of:
communicate the identified at least one FC to a user in order to adjust the at least one FC output; and
automatically adjust the at least one FC output without requiring user input.
